(19) United States
(12) Patent Application Publication
(10) Pub. No.: US 2015/0381979 A1
(43) Pub. Date: Dec. 31, 2015

(54) METHOD FOR USING A DECODER OR LOOK-AHEAD ENCODER TO CONTROL AN ADAPTIVE PRE-FILTER

(71) Applicant: ARRIS Enterprises, Inc., Suwanee, GA (US)

(72) Inventor: Wayne D. Michelsen, Santa Clara, CA (US)

(21) Appl. No.: 14/751,002

(22) Filed: Jun. 25, 2015

Related U.S. Application Data
(60) Provisional application No. 62/016,970, filed on Jun. 25, 2014.

(51) Int. Cl. H04N 19/117; H04N 19/14; H04N 19/51; H04N 19/86; H04N 19/82

(52) U.S. Cl. CPC H04N 19/117; H04N 19/86; H04N 19/82; H04N 19/51; H04N 19/14

(57) ABSTRACT

An adaptive video pre-filter system is provided that uses a blend of both spatially neighboring pixels and motion compensated neighboring pixels to produce a filtered output that has reduced pixel noise to drive a primary encoder. In one embodiment, the pre-filter is used with a look-ahead encoder that provides a complexity input control to a pre-filter enabling the pre-filter to provide a filtered video signal to a primary encoder. A complexity model is provided between the look-ahead encoder and the pre-filter to enable an increase or decrease in the filtering strength to be provided depending upon the complexity of the input signal. In a further embodiment, the look-ahead encoder is replaced with a decoder to provide complexity values. In some embodiments, a delay buffer is provided to buffer the complexity values between the complexity model and the pre-filter and buffering is further provided with the same delay to buffer the video frames to the pre-filter to smooth filtering in the pre-filter.

### CROSS REFERENCE TO RELATED APPLICATION

This Application claims priority under 35 U.S.C. §119(e) from earlier filed U.S. Provisional Application Ser. No. 62/016,970 filed on Jun. 25, 2014 and incorporated herein by reference in its entirety.

### BACKGROUND

1. Technical Field

The present invention relates to improving a process for video compression. More specifically, the present invention relates to applying Spatial Filtering and Motion Compensated Temporal Filtering (MCTF) during the video compression process.

2. Related Art

Both Spatial Filtering and MCTF are well known techniques incorporated in video filtering for improving video compression. In video encoding systems these filtering techniques are used to improve video compression efficiency by reducing noise from the incoming video. A problem is that current filters are statistically configured and do not adapt to the changing characteristics of the video content being processed.

### SUMMARY

In embodiments of the present invention a pre-filter is provided that uses a blend of both spatially neighboring pixels and motion compensated neighboring pixels to produce a filtered output that has reduced pixel noise. The operation of both spatial and motion compensated filters is modified based on signal complexity, resulting in an Adaptive Pre-Filter (APF). The cleaner output is then used as an input to the encoder.

In a first embodiment a system is provided with a look-ahead encoder that provides a complexity input control to a pre-filter, enabling the pre-filter to provide an improved video signal to a primary encoder. A complexity model (applied by a processing module) is provided between the look-ahead encoder and the pre-filter to enable an increase or decrease in the filtering strength depending upon the complexity of the input signal.

In a further embodiment, a system is provided with a decoder that provides the complexity input control to the pre-filter which, in turn, feeds a primary encoder. A complexity model is again used between the decoder and pre-filter to enable an increase or decrease in the filtering strength depending upon the input signal complexity.

In a further embodiment delay buffering is provided to buffer the complexity values between the complexity model and the pre-filter to provide smooth filtering. Buffering is further provided with the same delay to buffer the video frames to the pre-filter.

### BRIEF DESCRIPTION OF THE DRAWINGS

Further details of the present invention are explained with the help of the attached drawings in which:

FIG. 1 illustrates spatial filtering used in embodiments of the present invention for noise reduction;

FIG. 2 shows filter curves where an MCTF element is used for filtering;

FIG. 3 provides a block diagram illustrating a system with a look-ahead encoder providing complexity data to an adaptive pre-filter module;

FIG. 4 provides a block diagram illustrating a system with a decoder providing complexity data to an adaptive pre-filter module;

FIG. 5 provides a block diagram illustrating extra delay buffering to include in order to achieve smooth transitions in the adaptive pre-filter;

FIGS. 6 and 7 illustrate the two cases where the extra delay buffering of FIG. 5 is included for complexity determination for both a system with a look-ahead encoder and a decoder; and

FIG. 8 plots bitrate vs. frames provided over time with a Need Parameter (or complexity bitrate) shown with use of an adaptive pre-filter as well as with a static bitrate.

### DETAILED DESCRIPTION

### I. Filtering Algorithms

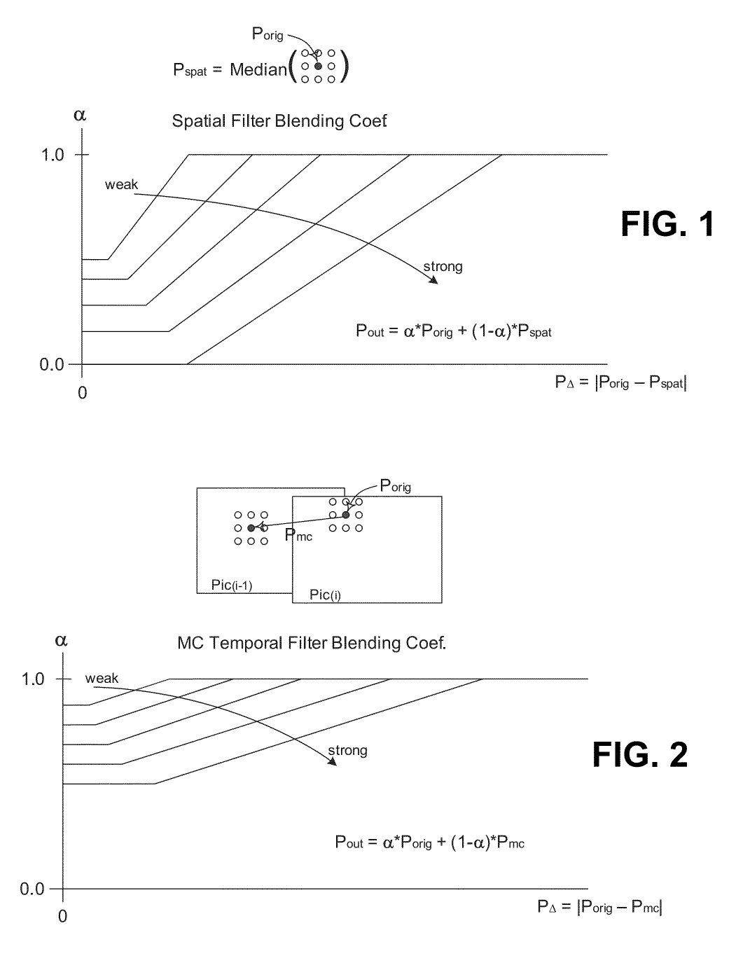

FIG. 1 illustrates spatial filtering that can be used in embodiments of the present invention for noise reduction. The spatially combined filter input Pₛₚₐₜ can be a median or mean combination of neighboring pixels P_{orig} as shown by the matrix equation for Pₛₚₐₜ above the graph in FIG. 1. The filtered output Pₒᵤₜ is then a blend of the original and spatially combined pixel values using the equation Pₒᵤₜ=α*P_{orig}(1−α)*Pₛₚₐₜ, where α is the blending coefficient. The blending coefficient (α) is computed based on the deviation of the filtered pixel from the original α=f(|P_{orig}−Pₛₚₐₜ|), and is represented by any single line in FIG. 1. For small pixel differences, and in cases where the motion field is not coherent, the spatially combined pixel value Pₛₚₐₜ is preferred for Pₒᵤₜ. For larger pixel differences, and when the motion field is highly coherent, the unmodified original pixel value P_{orig} alone can be used. FIG. 1 shows the filter curves, of varying strength, by plotting alpha values vs. the relative difference P_{Δ} between P_{orig} the Pₛₚₐₜ values, or P_{Δ}=|P_{orig}−Pₛₚₐₜ|.

FIG. 2 shows adaptive filter curves where an MCTF element is used in embodiments of the present invention. The motion compensated filter output Pₒᵤₜ can be a blended combination of the original pixel P_{orig} in the current picture Pic(i) with the motion compensated pixel P_{mc} found from a motion search in a previous picture Pic(i−1) as shown by the matrix equations above the graph in FIG. 2. In FIG. 2, each output pixel value Pₒᵤₜ is a blend of the original P_{orig} and motion compensated pixel P_{mc} according to the equation Pₒᵤₜ=α*P_{orig}(1−α)*P_{mc}. When the prediction error is low, and when the motion prediction is of high quality, a blend is preferred. As the prediction error increases, or if the motion prediction is poor, the output Pₒᵤₜ is equal to the original value P_{orig}. FIG. 2 shows the MCTF filter curves, of varying strength, by plotting alpha values vs. the relative difference P_{Δ} between P_{orig} the P_{mc} values, or P_{Δ}=|P_{orig}−P_{mc}|.

The amount of blending can be controlled by coefficients a as shown in the Pₒᵤₜ equations of FIGS. 1 and 2. where the curves are based on mathematical functions or empirical relationships. The series of curves in each figure represent filters of increasing strength from weak to strong. In an adaptive pre-filter of embodiments of the invention, the strength of the filter varies depending on the incoming picture complexity measure by selecting and applying the appropriate filter curve. Rather than configuring the pre-filter with a single curve relationship between prediction error and blend, the filter behavior will be controlled and modified on a picture-by-picture basis with curves varying as shown in FIGS. 1 and 2. This is done, individually, for both spatial filter and MCTF blocks of the adaptive pre-filter module.

### II. Placement of Pre-Filter in System.

A. Look-Ahead Encoder System for Complexity Determination

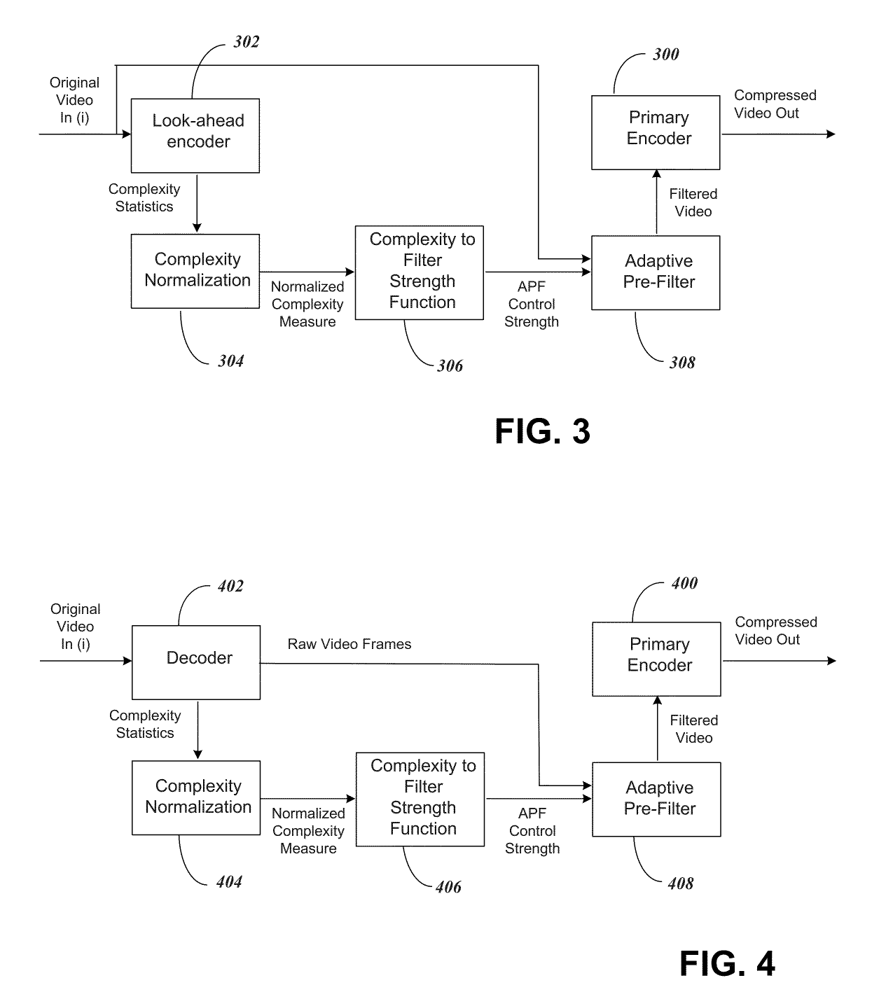

The present invention introduces two new ways to control an adaptive pre-filter system. In the first control method, statistics from a look-ahead encoder are used to develop a complexity measure. A mathematical model, lookup tables or an empirical relationship relate the complexity measurement from the look-ahead encoder to a Need Parameter. FIG. 3 provides a block diagram illustrating a system with a look-ahead encoder.

The system of FIG. 3 includes a primary encoder 300 and a look-ahead encoder 302. In FIG. 3, the complexity measurement from a look-ahead encoder 302 is used in modules 304 and 306 to control the strength of the adaptive pre-filter 308. The original video input (i) is provided to the look-ahead encoder 302 and the pre-filter 308. The complexity normalization module 304 receives complexity statistics from the look-ahead encoder 302 and normalizes the complexity value. The complexity to signal strength function module 306 applies a complexity strength function to create an APF Control Strength value that is provided to the adaptive pre-filter 308. The pre-filter 308 then uses the APF strength value to adaptively filter the raw video input that is provided to the primary encoder 300.

In the dual pass encoder of FIG. 3, a complexity value is extracted from the look-ahead encoder 302. The complexity estimation provided by modules 304 and 306 can be based on spatial detail measurements, correlation of motion vectors, quantization parameters, color detail, buffer fullness or other statistical measurements. A model has been developed relating the complexity of the look-ahead encoder parameters that control the strength of the adaptive pre-filter. The model maps complexity to the required strength of the filter and is provided in the modules 304 and 306. The model can be an empirical model, a lookup table or a mathematical relationship between the look-ahead complexity and control parameters for the adaptive pre-filter 308.

B. Decoder System for Complexity Determination

In the second method illustrated using the block diagram of FIG. 4, statistics from a decoder 402 are used to develop a complexity measure and Need Parameter. In FIG. 4, a decoder 402 replaces the look-ahead encoder 302 of FIG. 3, and the complexity statistics output from the decoder 402 are used to control the strength of the adaptive pre-filter 408.

In FIG. 4, a transcoder system is shown where there is no look-ahead encoder, just a single pass encoder 400 with complexity data provided from decoder 402. In this case, a new model is needed that can relate statistics from the decoder 402 to a complexity measurement. These statistics are applied in modules 404 and 406 and can be based on motion vectors, quantization parameters, coded block pattern values or other metrics. A complexity normalization model provided in module 404 relates these statistics to those that would have been produced had a look-ahead encoder been used. The normalized complexity is used to generate a parameter model in module 406 as before, and then if the codecs are of a different type, a conversion stage is introduced that maps the model from one codec type to another, based upon an empirical model, a lookup table or a mathematical relationship.

In a transcoder system such as shown in FIG. 4, a decoder and encoder may be used to convert an incoming bitstream at bit rate B1 to an outgoing bitstream at bit rate B2, where the incoming and outgoing bitstreams may utilize the same codec or a different codec. The incoming bitstream may be a transport stream or an elementary stream. In order to improve the quality of the output encoded bitstream, the adaptive pre-filter 408 is placed between the decoder and encoder as shown in FIG. 4.

C. Addition of Smoothing Delay Buffers

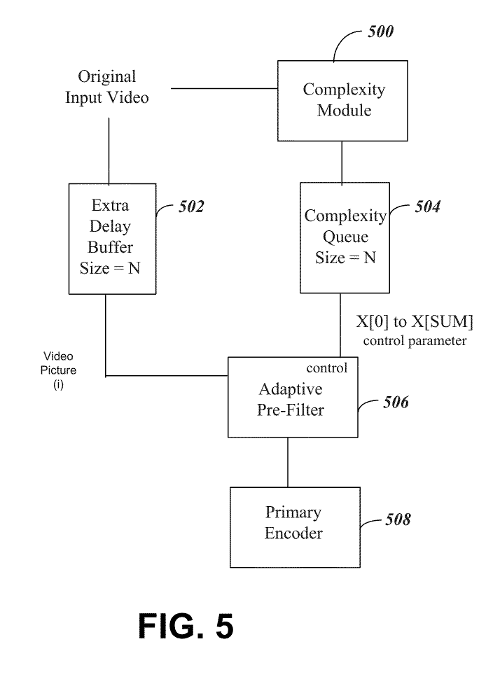

In order to achieve smooth and synchronized transitions in the adaptive pre-filter when a decoder system as shown in FIG. 4 is used, or even when a look-ahead encoder of FIG. 3 is used, an extra delay buffer can be added to the system as shown in FIG. 5. The extra delay provided in FIG. 5 enables a smooth and synchronized transition in the control parameter provided to the pre-filter.

In FIG. 5 the original video input is provided to a complexity determination module 500, but it is also provided through an extra delay buffer module 502 of size N. The output of the complexity module 500 is then provided through a similar complexity delay module 504 of size N. The video picture frame outputs (i) from the delay buffer 502 then provide video inputs to the pre-filter 506, while the buffered complexity values are queued to provide X[0]−X[SUM] control parameter complexity inputs from complexity delay module 604 to the adaptive pre-filter 506. The output of the pre-filter 506 then is provided to the primary encoder 508.

For the components of FIG. 5, the average complexity in the queue as well as the complexity of each frame is used to adjust the control parameter provided from the complexity delay module 504 to the pre-filter 506 using a sliding window. The relationship between the complexity and filter strength is determined using a model based on videos of different content, bitrate, codec type and other attributes. The model is used to determine a filter strength target for a given input complexity.

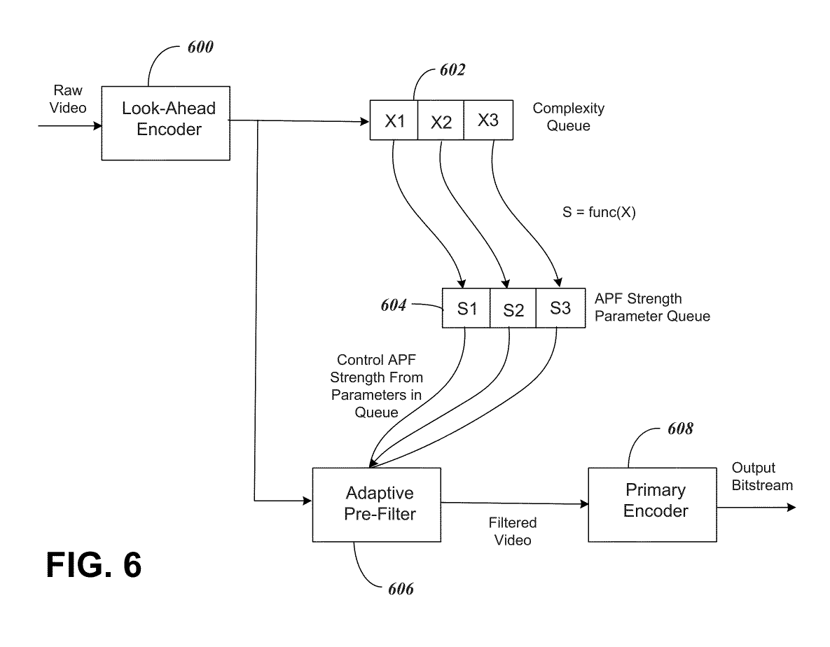

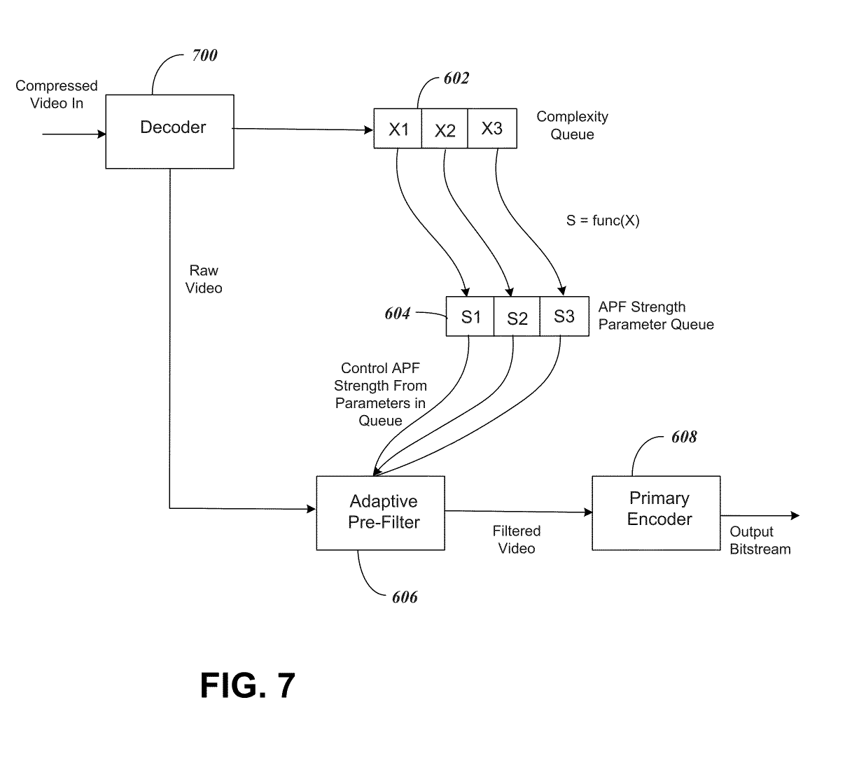

FIGS. 6 and 7 illustrate the two cases where the extra delay buffering of FIG. 5 is included for complexity determination for both a system with a look-ahead encoder and a decoder. In FIG. 6, the relationship between complexity values is determined from a look-ahead encoder, similar to FIG. 3, and strength determined is used to control adaptive pre-filter. In FIG. 7, the relationship between complexity values is determined by a decoder, similar to FIG. 4, and parameter strength used to control adaptive pre-filter.

For FIG. 6, the raw video is received in a look-ahead encoder 600, and the complexity statistics are provided to the complexity queue 602 shown with buffers X1-X3 as well as to the adaptive pre-filter 606. The function S=func(X) is applied to the values from queue 602 and the determined values are queued into the ATF Strength Parameter Queue 604 with buffers S1-S3 shown. The control values from the strength parameter queue 604 are then applied to control the pre-filter 606. The pre-filter 606 then produces adapted video to the primary encoder 608 which in turn produces the output bitstream.

In the system of FIG. 7 shown, the decoder 700 replaces the pre-encoder 600 of FIG. 6, but otherwise, the system components remain the same as those shown in FIG. 6. For the system of FIG. 7, a different model is used in the case where the decoder statistics are used to generate a control parameter for the adaptive pre-filter. This model can be empirical, a lookup table or a mathematical model and will take account of the input and output bitrates, codec types and other parameters. Alternatively, after the complexity is determined from the decoder, the complexity value could be normalized to a value that would have been produced had a look-ahead encoder been available using a function for conversion.

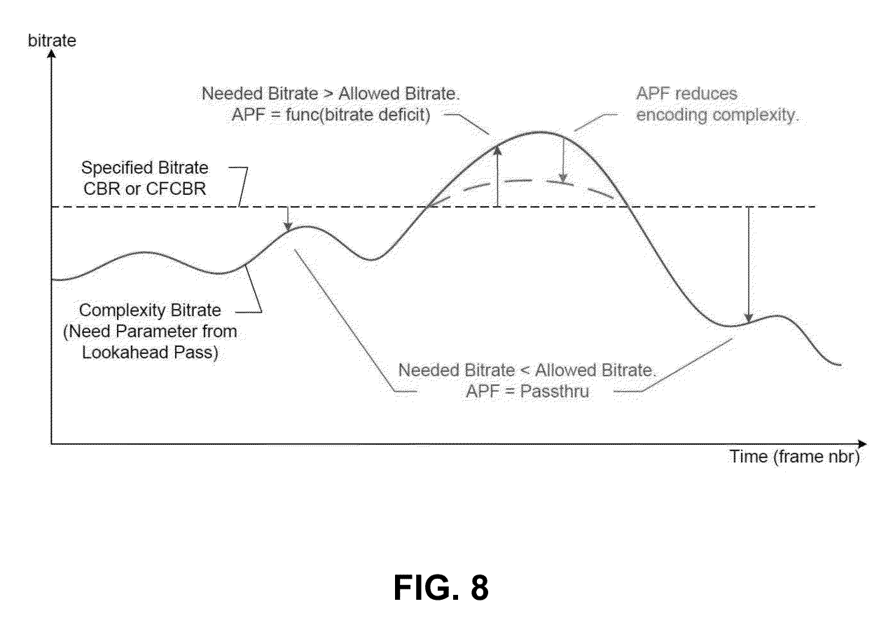

FIG. 8 plots bitrate vs. frames provided over time with a Need Parameter (or complexity bitrate) for adaptive pre-filter and a static bitrate plotted. A plot also shows the constant or specified bitrate parameter in a dashed line that provides a comparison should the variable complexity bitrate control not be provided through a pre-filter. As shown, the adaptive pre-filter reduces coding complexity when the Needed Bitrate is greater than the Allowed Bitrate. Also, it illustrates that with the system of embodiments of the present invention when the Needed Bitrate is less than the Allowed Bitrate, the bitrate is not altered by the adaptive pre-filter.

For embodiments of the present invention, the modules such as Complexity Normalization module 304, Complexity to Signal Strength Function module 306 and other components providing functions such as complexity determination and video processing for embodiments of the present invention can be provided in software. The software can be stored in computer readable code provided in a memory that is executable by one or more processors, all provided in the video coding and encoding system of the present invention.

Although the present invention has been described above with particularity, this was merely to teach one of ordinary skill in the art how to make and use the invention. Many additional modifications will fall within the scope of the invention as that scope is defined by the following claims.

What is claimed:

1. An encoder system comprising:
a primary encoder;
a look-ahead encoder receiving an input video signal;
a complexity to filter strength module receiving a complexity signal output from the look-ahead encoder and providing a filter strength control output signal; and
an adaptive pre-filter (APF) having a first input receiving the video signal and a second input receiving a control output from the filter strength module, pre-filter providing a filtered version of the video signal to the primary encoder.

2. The encoder system of claim 1, further comprising:
a complexity delay buffer providing the complexity signal output from the complexity module to the pre-filter; and
a frame delay buffer providing the video signal from the look-ahead encoder to the pre-filter.

3. The encoder system of claim 1, wherein spatial filtering and MCTF filtering are alternatively applied by the adaptive pre-filter depending on the complexity of the input signal.

4. The encoder system of claim 1, wherein different strengths of both spatial and MCTF filtering are alternatively applied depending on the complexity of the input signal.

5. The encoder system of claim 1, wherein the complexity to signal strength module comprises:
a complexity normalization module receiving the output of the look-ahead encoder which provides complexity statistics, the complexity normalization module providing a normalized complexity measure output; and
a complexity to filter strength function module receiving the complexity normalization module output and providing a an APF control strength signal output to the adaptive pre-filter.

6. The encoder system of claim 1, wherein the complexity module comprises:
a complexity queue receiving complexity outputs from the look-ahead encoder;
an apf strength parameter queue receiving the output of the complexity queue to which a function S=func(X) is applied,
wherein X is the complexity queue output and S is the input of the apf strength queue, and func is a predetermined function providing a complexity measure; and
wherein the output of the apf strength parameter queue is provided as a control APF strength signal to the adaptive pre-filter.

7. The encoder system of claim 1, wherein the adaptive pre-filter provides spatial filtering, wherein the output of the encoder Pₒᵤₜ is determined using the formula Pₒᵤₜ=α*P_{orig}+(1−α)*Pₛₚₐₜ, where α is a blending coefficient, P_{orig} is the original pixal value, and Pspat is a spatially combined filter output.

8. The encoder system of claim 1, wherein the adaptive pre-filter provides MCTF filtering, wherein the output of the encoder Pₒᵤₜ is determined using the formula Pₒᵤₜ=α*P_{orig}+(1−α)*P_{mc}, where α is a blending coefficient, P_{orig} is the original pixal value, and Pmc is a motion compensated filter output.

9. A video processing system comprising:
a primary encoder;
a decoder receiving a compressed input video signal;
a complexity to filter strength module receiving a complexity signal output from the decoder and providing a filter strength control output signal; and
an adaptive pre-filter (APF) having a first input receiving the compressed input video signal and a second input receiving a control output from the filter strength module, the pre-filter providing a filtered version of the video signal to the primary encoder.

10. The video processing system of claim 9, further comprising:
a complexity delay buffer providing the complexity signal output from the complexity module to the pre-filter; and
a frame delay buffer providing the video signal from the look-ahead encoder to the pre-filter.

11. The video processing system of claim 9, wherein spatial filtering and MCTF filtering are alternatively applied by the adaptive pre-filter depending on the complexity of the input signal.

12. The video processing system of claim 9, wherein different strengths of both spatial and MCTF filtering are alternatively applied depending on the complexity of the input signal.

13. The video processing system of claim 9, wherein the complexity to signal strength module comprises:
a complexity normalization module receiving the output of the look-ahead encoder which provides complexity statistics, the complexity normalization module providing a normalized complexity measure output; and
a complexity to filter strength function module receiving the complexity normalization module output and providing a an APF control strength signal output to the adaptive pre-filter.

14. The video processing system of claim 9, wherein the complexity module comprises:
a complexity queue receiving complexity outputs from the look-ahead encoder;
an apf strength parameter queue receiving the output of the complexity queue to which a function S=func(X) is applied,
wherein X is the complexity queue output and S is the input of the apf strength queue, and func is a predetermined function providing a complexity measure; and
wherein the output of the apf strength parameter queue is provided as a control APF strength signal to the adaptive pre-filter.

15. The video processing system of claim 9, wherein the adaptive pre-filter provides spatial filtering, wherein the output of the encoder Pₒᵤₜ is determined using the formula Pₒᵤₜ−α*P_{orig}+(1−α)*Pₛₚₐₜ, where α is a blending coefficient, P_{orig} is the original pixal value, and Pspat is a spatially combined filter output.

16. The video processing system of claim 9, wherein the adaptive pre-filter provides MCTF filtering, wherein the output of the encoder Pₒᵤₜ is determined using the formula Pₒᵤₜ=α*P_{orig}+(1−α)*P_{mc}, where α is a blending coefficient, P_{orig} is the original pixal value, and Pmc is a motion compensated filter output.
